(19) United States
(12) Patent Application Publication
(10) Pub. No.: US 2014/0030570 A1
(43) Pub. Date: Jan. 30, 2014

(54) BATTERY PACKAGE AND RESIN CASE FOR HOLDING BATTERY

(71) Applicants: Yoshiaki IMANISHI, Osaka (JP); Daisuke SUMIMOTO, Osaka (JP); Shinichi KAWAGUCHI, Osaka (JP); Hiroshi HASE, Osaka (JP)

(72) Inventors: Yoshiaki IMANISHI, Osaka (JP); Daisuke SUMIMOTO, Osaka (JP); Shinichi KAWAGUCHI, Osaka (JP); Hiroshi HASE, Osaka (JP)

(73) Assignee: PANASONIC CORPORATION, Osaka (JP)

(21) Appl. No.: 13/615,298

(22) Filed: Sep. 13, 2012

(30) Foreign Application Priority Data
Jul. 27, 2012 (JP) 2012-166748

(51) Int. Cl. H01M 2/10

(52) U.S. Cl. 429/100

(57) ABSTRACT

A flat battery is configured such that a sealing plate which serves as a negative electrode surface seals a battery case which serves as a positive electrode surface, with a gasket interposed therebetween. The flat battery is held in a resin case, and in this state the flat battery is contained in a battery package. The resin case includes an open end face through which the battery is inserted and removed, a side portion and a bottom portion which hold a side surface and/or a bottom surface of the battery, and a ring-shaped protrusion which protrudes radially inward from an edge of the side portion. The protrusion is supported on the edge in a bendable manner, and an inner diameter of the protrusion is smaller than an inner diameter of an exposed portion of the gasket. An emetic agent is applied to an outer surface of the resin case.

### BACKGROUND

The present disclosure relates to battery packages having a containing space in which a disc-like flat battery is to be contained.

Disc-like flat batteries, such as button batteries, etc., are thin and small, and therefore, infants may accidentally swallow them.

Thus, to avoid the accidental swallowing, electronic devices using a button battery as a power source include a lock mechanism that locks the containing space in which the button battery is contained, so that the button battery cannot be easily removed by infants.

However, if the button battery is left unattended during replacement of button batteries, there is a possibility that infants may accidentally swallow the button battery. Further, replaced button batteries are collected to be disposed. If a lot of naked button batteries are piled in a collecting box, small metal chips or the like may serve as a bridge, and a short circuit between the positive electrode and the negative electrode may occur. If capacity is left in the button batteries, heat may be generated due to a short-circuit current, and the batteries may catch fire.

To avoid this, Japanese Patent Application No. S59-44762, for example, discloses applying substances such as bitter agents, which infants dislike, to a surface of the button battery so that infants who accidentally put a button battery in their mouths may immediately spit the battery out to avoid swallowing of the battery into their bodies.

Japanese Utility Model Publication No. S59-192262 discloses covering the button battery, except an electrode terminal, with an insulator having a rectangular outer shape so that infants who accidentally put a button battery in their mouths may feel uncomfortable in their mouths to avoid swallowing of the battery into their bodies.

### SUMMARY

If the substances such as bitter agents are applied to the surface of the button battery, the button battery may have a poor contact when inserted in the electronic devices because such substances do not have conductivity.

Further, if the button battery is covered with a rectangular insulator, it changes the outer dimensions of the button battery. Accordingly, the button battery is less versatile, and can only be used in a limited range of electronic devices.

Moreover, effective solutions for a short circuit fault during collection of naked button batteries have not yet been developed.

The present disclosure is made in view of the above problems, and it is an main objective of the invention to provide a battery package which can avoid accidental swallowing of a disc-like flat battery, and avoid a short circuit fault during collection of batteries.

A battery package according to the present disclosure includes a containing space for containing a disc-like flat battery, wherein the flat battery is configured such that a sealing plate which also serves as a first electrode surface hermetically seals a battery case which also serves as a second electrode surface, with a ring-shaped gasket interposed between the battery case and the sealing plate, the flat battery is held in a resin case, and in this state the flat battery is contained in the containing space, the resin case includes an open end face through which the flat battery is inserted and removed from an electrode surface of the flat battery, a side portion and a bottom portion which hold a side surface and/or a bottom surface of the flat battery, and a ring-shaped protrusion which protrudes radially inward from an edge of the side portion closer to the open end face, the protrusion is supported on the edge in a bendable manner, and an inner diameter of the protrusion is smaller than an inner diameter of an exposed portion of the gasket, and an emetic agent is applied to an outer surface of the side portion and/or the bottom portion of the resin case.

In this configuration, an emetic agent is applied to the outer surfaces of the side portion and/or the bottom portion of the resin case which holds the flat battery. Thus, even if an infant accidentally puts the resin case in his/her mouth, the emetic agent makes the infant immediately spit the resin case out, and prevents the infant from swallowing the flat battery. Here, no emetic agent is applied to the flat battery. Thus, the battery does not have a poor contact when inserted in electronic devices. Further, a ring-shaped protrusion is provided at the edge of the resin case closer to the open end face. Thus, a short circuit fault can be avoided during collection of a replaced battery by accommodating the replaced battery in the resin case during the collection.

In the battery package according to the present disclosure, the flat battery is held in the resin case, and in this state the flat battery is contained in the containing space of the battery package. The user who bought this battery package on the market removes the resin case, in which the flat battery is held, from the battery package, and then takes the battery out of the resin case before he/she inserts the battery in an electronic device. Thus, even if the flat battery removed from the battery package is left unattended until it is inserted in the electronic device, the battery can be prevented from being accidentally swallowed by an infant because the battery is held in the resin case. Further, the resin case from which the battery has been taken out can be used again to accommodate the replaced battery during collection of the replaced battery. As a result, it is possible to prevent a short circuit fault during the collection of the battery.

According to the present disclosure, it is possible to avoid accidental swallowing of a disc-like flat battery, and possible to avoid a short circuit fault during collection of batteries, using a simple structure.

### BRIEF DESCRIPTION OF THE DRAWINGS

FIG. 1 is a cross-sectional view of a configuration of a disc-like flat battery according to an embodiment of the present disclosure.

FIG. 2A to FIG. 2C show cross-sectional views illustrating the steps for holding a battery in a resin case.

FIG. 3 is a plan view of a configuration of the resin case according to an embodiment of the present disclosure.

FIG. 4A is a plan view of a configuration of a battery package according to an embodiment of the present disclosure. FIG. 4B is a cross-sectional view taken along the line B-B in FIG. 4A.

FIG. 5A to FIG. 5C show cross-sectional views illustrating other steps for holding a battery in the resin case.

FIG. 6 is an enlarged cross-sectional view of the resin case in the state shown in FIG. 5C.

FIG. 7 is an oblique view of a variation of the resin case according to an embodiment of the present disclosure.

FIG. 8 is a cross-sectional view of another variation of the resin case according to an embodiment of the present disclosure.

FIG. 9A and FIG. 9B show cross-sectional views illustrating the steps for holding batteries of different thicknesses in the resin case.

### DETAILED DESCRIPTION

An embodiment of the present disclosure will be described in detail below based on the drawings. The present disclosure is not limited to the embodiment below. Further, the embodiment can be properly modified without deviating from the effective scope of the present disclosure.

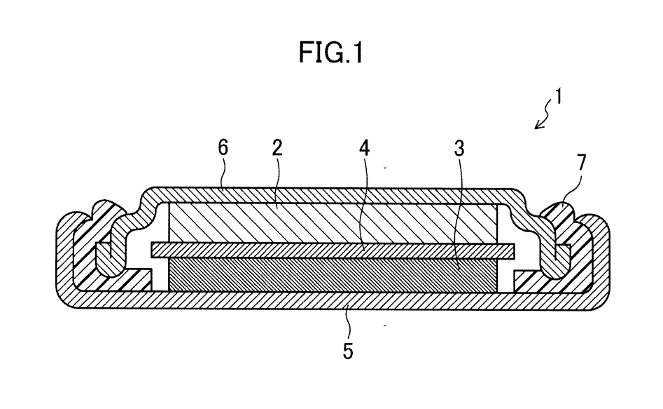

FIG. 1 is a cross-sectional view which schematically illustrates a configuration of a disc-like flat battery 1 according to an embodiment of the present disclosure. The disc-like flat battery 1 is a thin, disc-like battery, such as a button battery and a coin battery. The battery may be any type. For example, the battery may be a primary battery or a secondary battery. Hereinafter, the disc-like flat battery 1 is simply referred to as a “battery.” The battery shown in FIG. 1 as an example is a lithium battery.

As shown in FIG. 1, a negative electrode 2 having lithium or a lithium alloy as a negative electrode active material, and a positive electrode 3 having graphite fluoride as a positive electrode active material, with a separator 4 interposed therebetween, are housed in a battery case 5 together with an electrolyte. The opening of the battery case 5 is sealed with a sealing plate 6 via a ring gasket 7. The positive electrode 3 is in contact with a bottom of the battery case 5, and the bottom of the battery case 5 also serves as a positive electrode surface. The negative electrode 2 is in contact with the sealing plate 6, and an upper surface of the sealing plate 6 also serves as a negative electrode surface. The outer diameter of the negative electrode surface 6 is smaller than the outer diameter of the positive electrode surface 5, and a negative electrode terminal forms a protruding electrode portion.

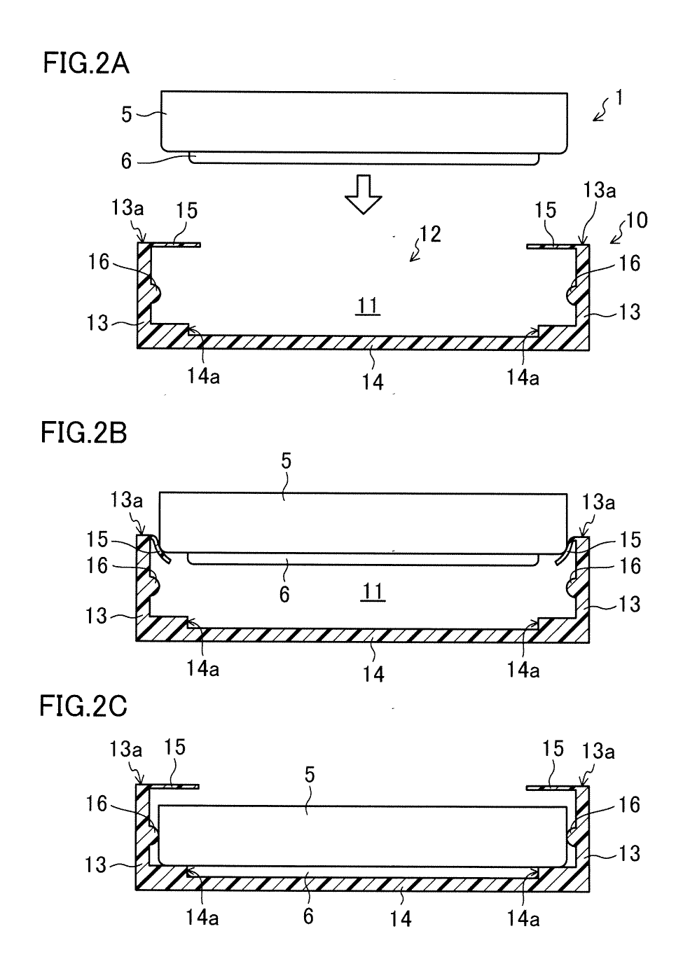

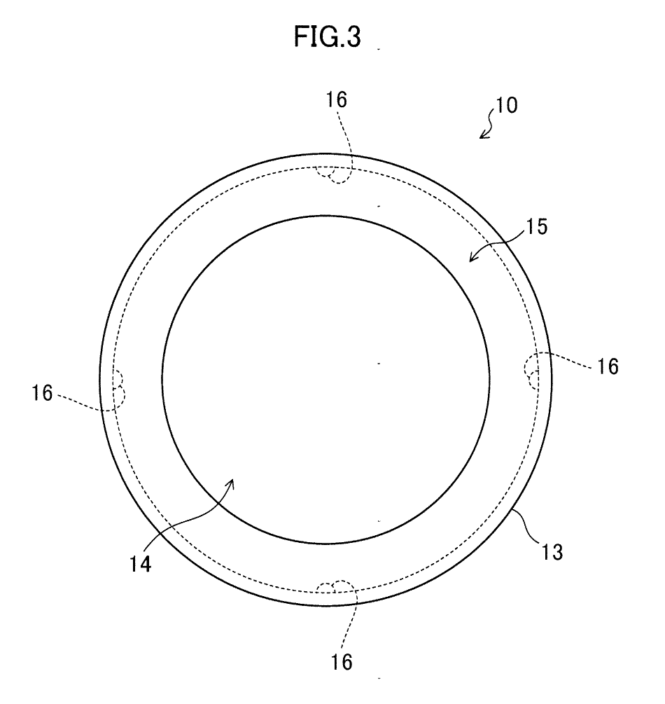

FIG. 2A to 2C are cross-sectional views illustrating the steps for holding (i.e., containing) the battery 1 in a resin case 10. FIG. 3 is a plan view of the resin case 10. Here, only the positive electrode surface 5 and the negative electrode surface 6 are shown as the battery 1.

As shown in FIG. 2A and FIG. 3, the resin case 10 has an open end face 12 through which the battery 1 is inserted and removed from the electrode surface of the battery 1, and a side portion 13 and a bottom portion 14 which hold the side surface and/or the bottom surface of the battery 1. This means that an accommodation space 11 for accommodating the battery 1 is formed in the resin case 10. The resin case 10 also has a ring-shaped protrusion 15 which protrudes radially inward from an edge 13a of the side portion 13 closer to the open end face 12. The protrusion 15 is supported on the edge 13a in a bendable manner. Further, an emetic agent is applied to the outer surfaces of the side portion 13 and/or the bottom portion 14 of the resin case 10.

A raised portion 16 which energizes the side surface of the battery 1 is formed on the inner circumferential surface of the side portion 13 of the resin case 10. The shape of the raised portion 16 is not specifically limited, but as shown in FIG. 3, four raised portions 16 may be provided on the side portion 13 of the resin case 10 with equal intervals between each other in a circumferential direction of the side portion 13, for example. Further, a recessed portion 14a is formed in the bottom portion 14 of the resin case 10, for receiving the protruding electrode portion including the negative electrode surface 6.

When the battery 1 is inserted in the accommodation space 11 of the resin case 10 in the arrow direction as shown in FIG. 2A, the periphery of the positive electrode surface 5 of the battery 1 comes in contact with the ring-shaped protrusion 15 as shown in FIG. 2B. If the protrusion 15 is made of a deformable elastic member, the protrusion 15 is deformed as the battery 1 enters the accommodation space 11 of the resin case 10 as shown in FIG. 2B. Then, as shown in FIG. 2C, the protruding electrode portion including the negative electrode surface 6 is buried in the recessed portion 14a formed in the bottom portion 14 of the resin case 10. After the battery 1 passes through the protrusion 15, the protrusion 15 returns to its original position due to the elasticity. In this state, the side surface of the battery 1 is held in the accommodation space 11 by being energized by the raised portions 16 formed on the side portion 13 of the resin case 10.

In the present disclosure, an emetic agent is applied to the outer surfaces of the side portion 13 and/or the bottom portion 14 of the resin case 10 which holds the battery 1. Thus, even if an infant accidentally puts the battery 1 in his/her mouth, the emetic agent makes the infant immediately spit the battery out, and prevents the infant from swallowing the battery into his/her body. Here, no emetic agent is applied to the battery 1. Thus, the battery 1 does not have a poor contact when inserted in electronic devices.

Further, since the protruding electrode portion including the negative electrode surface 6 is buried in the recessed portion 14a formed in the bottom portion 14 of the resin case 10, insulation between the negative electrode surface 6 and the positive electrode surface 5 is ensured by the bottom portion 14 of the resin case 10. Accordingly, a short circuit fault can be avoided during collection of a replaced battery 1 by accommodating the replaced battery 1 in the resin case 10 during the collection.

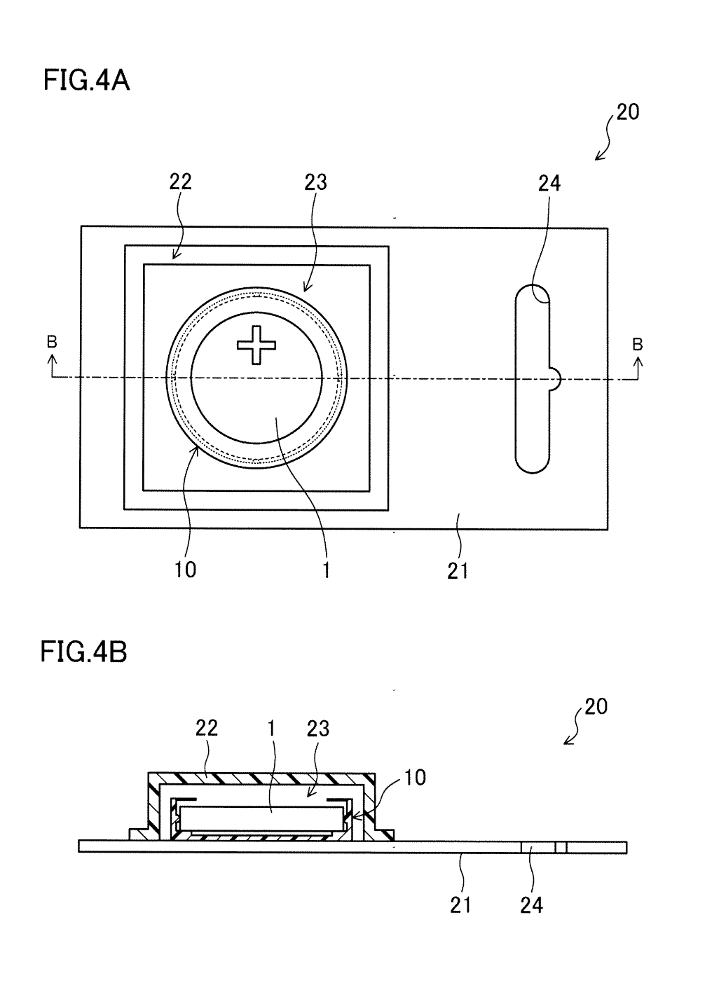

FIGS. 4A and 4B schematically show a configuration of a battery package 20 containing the flat battery 1 according to an embodiment of the present disclosure. FIG. 4A is a plan view. FIG. 4B is a cross-sectional view taken along the line B-B of FIG. 4A.

As shown in FIGS. 4A and 4B, the battery package 20 is a blister pack including a main cover 22 which forms a containing space 23 for containing the flat battery 1, and a base 21 which closes the containing space 23 of the main cover 22. The flat battery 1 is contained in the containing space 23 while being held in the resin case 10. The base 21 is provided with a hole 24 so that the battery package 20 may be hung.

The user who bought the battery package 20 on the market removes the resin case 10, in which the battery 1 is held, from the battery package 20, and then takes the battery 1 out of the resin case 10 before he/she inserts the battery 1 in an electronic device. Thus, even if the battery 1 removed from the battery package 20 is left unattended until it is inserted in the electronic device, the battery 1 can be prevented from being accidentally swallowed by an infant because the battery 1 is held in the resin case 10. Further, the resin case 10 from which the battery 1 has been taken out can be used again to accommodate the replaced battery 1 during collection of the replaced battery 1. As a result, it is possible to prevent a short circuit fault during the collection of the battery.

The battery 1 can be taken out of the resin case 10 by pushing the bottom portion 14 of the resin case 10 in a direction toward the battery 1 against the energizing force of the raised portion 16. The battery 1 can be taken out more easily particularly because the recessed portion 14a formed in the bottom portion 14 of the resin case 10 has a thin resin thickness.

When the battery 1 is inserted from the negative electrode surface 6 as shown in FIGS. 2A to 2C, the protruding electrode portion including the negative electrode surface 6 is buried in the recessed portion 14a formed in the bottom portion 14 of the resin case 10. It is thus possible to prevent a short circuit fault between the positive electrode surface 5 and the negative electrode surface 6.

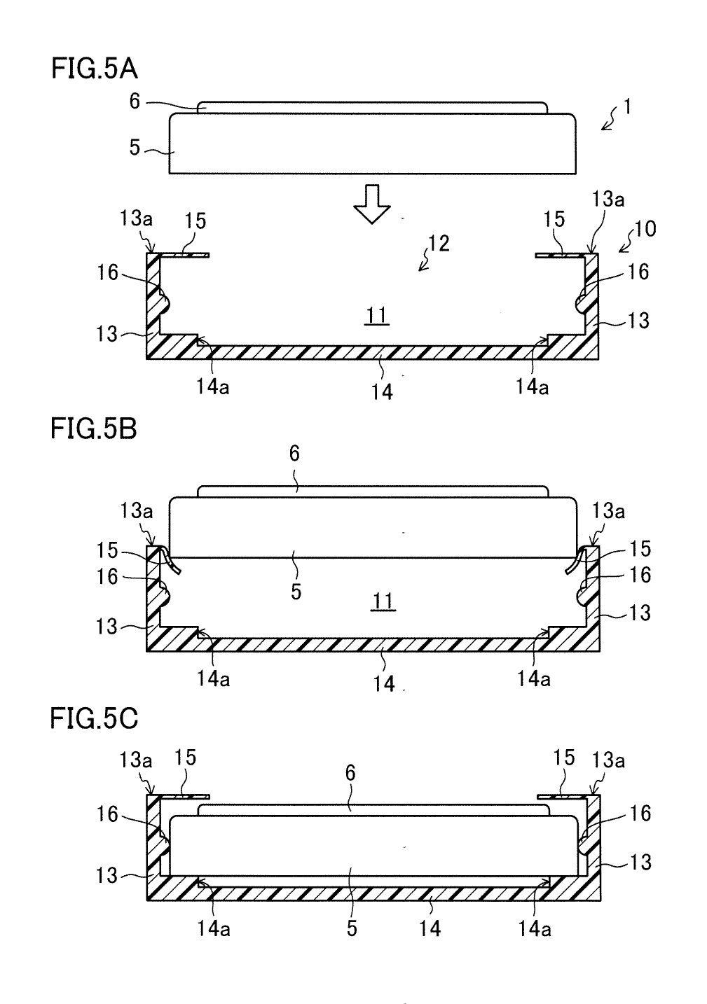

However, it may happen that the user inserts the battery 1 from the positive electrode surface 5 as shown in FIGS. 5A to 5C.

In the present disclosure, it is possible to prevent a short circuit fault between the positive electrode surface 5 and the negative electrode surface 6 in such a situation as well. Explanation will be made below with reference to FIGS. 5A to 5C.

First, when the battery 1 is inserted in the accommodation space 11 of the resin case 10 in the arrow direction as shown in FIG. 5A, the periphery of the positive electrode surface 5 of the battery 1 comes in contact with the ring-shaped protrusion 15, and the protrusion 15 is deformed as shown in FIG. 5B. Then, as shown in FIG. 5C, the positive electrode surface 5 comes in contact with the bottom portion 14 of the resin case 10 and stops there, because the outer diameter of the positive electrode surface 5 is greater than the outer diameter of the negative electrode surface 6. After the battery 1 passes through the protrusion 15, the protrusion 15 returns to its original position due to the elasticity. In this state, the side surface of the battery 1 is held in the accommodation space 11 by being energized by the raised portions 16 formed on the side portion 13 of the resin case 10.

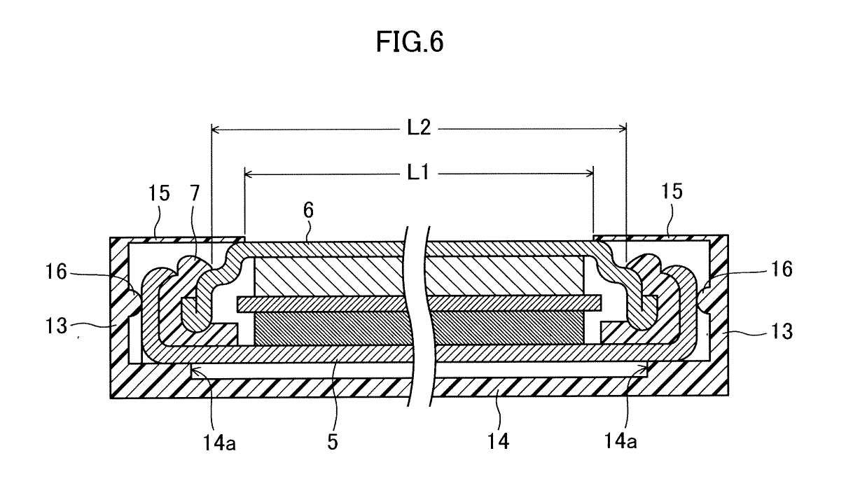

FIG. 6 is an enlarged cross-sectional view of the resin case in the state shown in FIG. 5C.

As shown in FIG. 6, the battery 1 is not buried in the recessed portion 14a formed in the bottom portion 14 of the resin case 10. Thus, the battery 1 is held in the accommodation space 11 at a position closer to the protrusion 15 by the depth of the recessed portion 14a, compared to the position shown in FIG. 2C.

As shown in FIG. 6, if the inner diameter L1 of the protrusion 15 is smaller than the inner diameter L2 of an exposed portion of the gasket 7, the protrusion 15 overlaps the positive electrode surface 5. Accordingly, even when the replaced battery 1 is accommodated in the resin case 10 for collection, it is possible to prevent a short circuit fault between the positive electrode surface 5 and the negative electrode surface 6.

In FIG. 6, the radially inward end of the protrusion 15 is in contact with the negative electrode surface 6 of the battery 1. However, even if the radially inward end of the protrusion 15 is not in contact with the negative electrode surface 6, and there is some gap between the radially inward end of the protrusion 15 and the negative electrode surface 6, it is possible to prevent a short circuit fault between the positive electrode surface 5 and the negative electrode surface 6 as long as the radially inward end of the protrusion 15 overlaps with the positive electrode surface 5.

In the present disclosure, materials for the emetic agent applied to the outer surfaces of the side portion 13 and/or the bottom portion 14 of the resin case 10 are not specifically limited as long as they are substances with a taste that makes people spit the substances out of their mouths. For example, denatonium benzoate, chrysanthemum extracts, cork tree extracts, etc., can be used as bitter substances. Capsaicin, sinigrin, etc., can be used as pungent substances. Instead of applying the emetic agent to the outer surfaces of the resin case 10, the emetic agent may be mixed beforehand in the resin which forms the resin case 10.

In the present disclosure, materials for the resin case 10 are not specifically limited.

For example, polypropylene (PP), polyethylene terephthalate (PET), etc., can be used as the materials for the resin case 10. The side portion 13, the bottom portion 14, and the protrusion 15 of the resin case 10 may be integrally formed by injection molding. Alternatively, the protrusion 15 made of a deformable elastic member is insert molded during molding of the resin case 10.

Further, directions for use of the flat battery 1, etc., may be shown on the bottom portion 14 of the resin case 10. For example, safety cautions (regarding accidental swallowing, short circuits, etc.) may be shown on the bottom portion 14 of the resin case 10.

In the present disclosure, the flat battery 1 is held in the resin case 10, and in this state the flat battery 1 is contained in the containing space 23 of the battery package 20, such as a blister pack. Further, a function for preventing accidental swallowing and a function for preventing a short circuit are added to the resin case 10 to avoid accidental swallowing and a short circuit fault. The resin case 10 can be achieved in a simple configuration. Moreover, the dimensions of the resin case 10 are determined according to battery specifications. Thus, the resin case 10 is highly versatile, and therefore, the resin case 10 can not only be used in the battery package 20, but also be used as a resin case 10 for holding a battery.

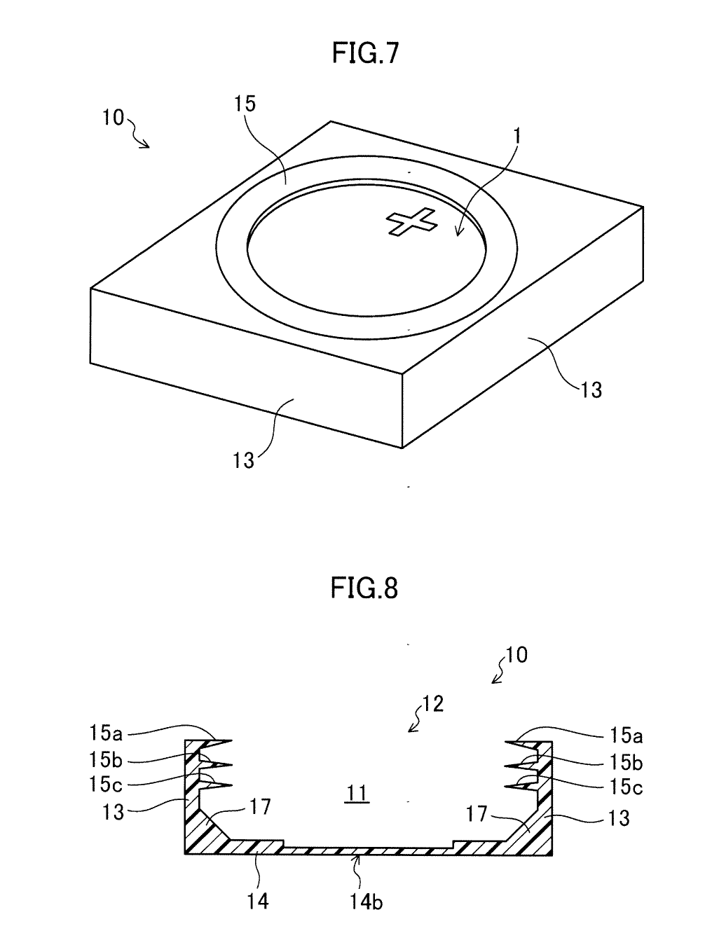

FIG. 7 is an oblique view of a variation of the resin case 10 according to the present embodiment.

The resin case 10 shown in FIG. 2A and FIG. 3 is made to have a function for preventing accidental swallowing by applying an emetic agent to the outer surfaces of the side portion 13 and/or the bottom portion 14 of the resin case 10. However, in the present variation, the resin case 10 itself has a rectangular outer shape to give the resin case 10 the function for preventing accidental swallowing.

The open end face of the resin case 10 shown in FIG. 7 through which the battery 1 is inserted and removed is in a circular shape whose diameter is almost the same as the diameter of the positive electrode surface 5 of the battery 1, and includes a ring-shaped protrusion 15 which protrudes radially inward from an edge of the open end face. On the other hand, the side portion 13 of the resin case 10 is in a quadrangle shape in plan view.

According to the present variation, the infant who accidentally puts the resin case 10 holding the battery 1 in his/her mouth may feel uncomfortable in the mouth since the resin case 10 is in a square shape. It is therefore possible to prevent the infant from swallowing the battery into his/her body. The outer shape of the resin case 10 is not limited to a quadrangle shape in plan view, but may be a polygonal shape.

FIG. 8 is a cross-sectional view of another variation of the resin case 10 according to the present embodiment.

As shown in FIG. 8, the resin case 10 has an open end face 12 through which the battery 1 is inserted and removed from the electrode surface of the battery 1, a side portion 13 and a bottom portion 14 which hold the side surface and/or the bottom surface of the battery 1, and three ring-shaped protrusions 15a, 15b, 15c which protrude radially inward from the side portion 13. Each of the protrusions 15a, 15b, 15c is supported on the side portion 13 in a bendable manner, and the inner diameter of each of the protrusions 15a, 15b, 15c is smaller than the inner diameter of the exposed portion of the gasket (not shown). A thin portion 14b with a reduced thickness is formed at a central portion of the bottom portion 14. A tapered surface 17 is formed at a corner formed by the side portion 13 and the bottom portion 14.

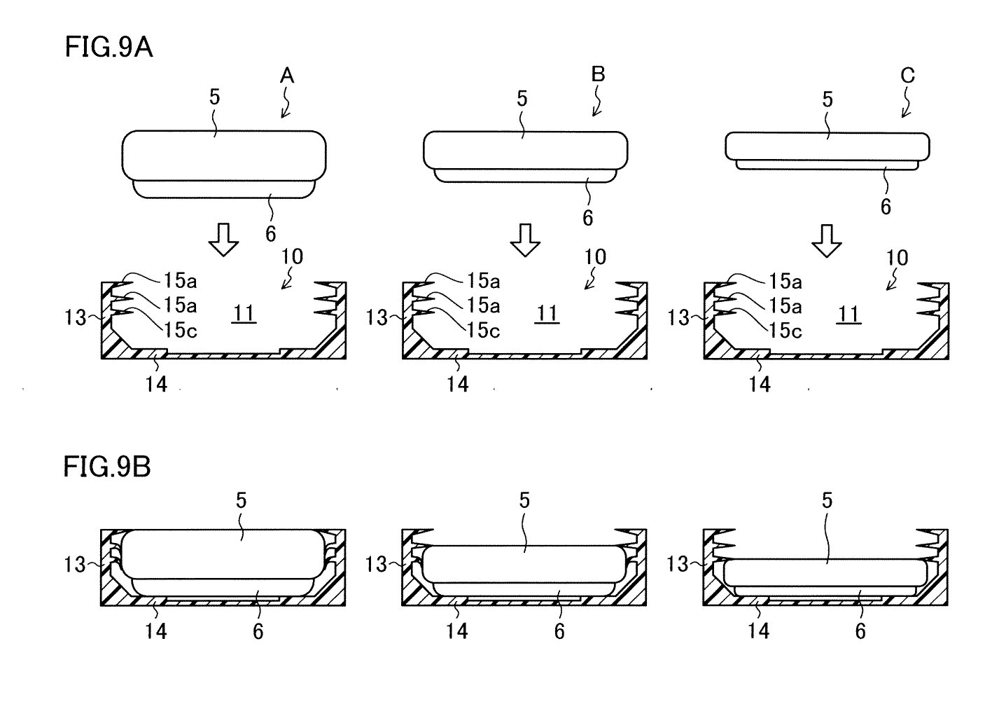

FIGS. 9A and 9B show cross-sectional views illustrating the steps for holding (i.e., containing) three types of batteries A, B, C having different thicknesses in the resin case 10.

As shown in FIG. 9B, when the thickest battery A is contained in the resin case 10, the protrusion 15a overlaps the positive electrode surface 5 of the battery A. The other protrusions 15b, 15c are deformed and hold the battery A by energizing the side surface of the battery A. That is, in the present variation, the protrusion 15a corresponds to the protrusion 15 shown in FIG. 2A and FIG. 3, and the protrusions 15b, 15c correspond to the raised portions 16 shown in FIG. 2A and FIG. 3.

As shown in FIG. 9B, when each of the batteries B, C with smaller thicknesses than the thickness of the battery A is contained in the resin case 10, the protrusion 15b overlaps the positive electrode surface 5 of the battery B, and the protrusion 15c overlaps the positive electrode surface 5 of the battery C.

As described above, a plurality of protrusions 15 are provided at different heights of the side portion 13 of the resin case 10. Thus, even if batteries 1 with different thicknesses are used, one of the protrusions 15 may overlap the positive electrode surface 5 of the battery 1. This is particularly advantageous in preventing a short circuit fault during collection of a replaced battery 1 because the protrusion 15 can overlap the positive electrode surface 5 of the battery 1 when the battery 1 is inserted in the resin case 10 from the positive electrode surface 5 as shown in FIGS. 5A to 5C. Further, the battery 1 accommodated in the resin case 10 can be easily taken out of the resin case 10 by pushing the thin portion 14b formed in the bottom portion 14 of the resin case 10.

The above embodiment has been described for the understanding of the present disclosure. However, the present disclosure is not limited to these descriptions, and of course, capable of various modifications. For example, in the above embodiment, a blister pack is used as an example of the battery package. However, the battery package is not limited to a blister pack, but may be a pillow package, etc., made of tubular package film, for example.

What is claimed is:

1. A battery package, comprising:
a containing space for containing a disc-like flat battery, wherein
the flat battery is configured such that a sealing plate which also serves as a first electrode surface hermetically seals a battery case which also serves as a second electrode surface, with a ring-shaped gasket interposed between the battery case and the sealing plate,
the flat battery is held in a resin case, and in this state the flat battery is contained in the containing space,
the resin case includes
an open end face through which the flat battery is inserted and removed from an electrode surface of the flat battery,
a side portion and a bottom portion which hold a side surface and/or a bottom surface of the flat battery, and
a ring-shaped protrusion which protrudes radially inward from an edge of the side portion closer to the open end face,
the protrusion is supported on the edge in a bendable manner, and an inner diameter of the protrusion is smaller than an inner diameter of an exposed portion of the gasket, and
an emetic agent is applied to an outer surface of the side portion and/or the bottom portion of the resin case.

2. The battery package of claim 1, wherein
instead of applying the emetic agent to the outer surface of the side portion and/or the bottom portion of the resin case, the resin case has a rectangular outer shape.

3. The battery package of claim 1, wherein
a raised portion which energizes the side surface of the flat battery is formed on an inner circumferential surface of the side portion of the resin case.

4. The battery package of claim 1, wherein
the protrusion is made of a deformable, elastic member.

5. The battery package of claim 4, wherein
the side portion, the bottom portion, and the protrusion of the resin case are integrally formed by injection molding.

6. The battery package of claim 1, wherein
a recessed portion for receiving a protruding electrode portion including the first electrode surface is formed in the bottom portion of the resin case.

7. The battery package of claim 1, wherein
a direction for use of the flat battery is shown on the bottom portion of the resin case.

8. The battery package of claim 1, wherein
the battery package is a blister pack having a main cover which forms the containing space for containing the flat battery, and a base which closes a recessed portion of the main cover.

9. A resin case for holding a battery, the resin case being used in the battery package of any one of claims 1-8, wherein
the resin case includes
an open end face through which the flat battery is inserted and removed from an electrode surface of the flat battery,
a side portion and a bottom portion which hold a side surface and/or a bottom surface of the flat battery, and
a ring-shaped protrusion which protrudes radially inward from an edge of the side portion closer to the open end face,
the protrusion is supported on the edge in a bendable manner, and an inner diameter of the protrusion is smaller than an inner diameter of an exposed portion of the gasket, and
an emetic agent is applied to an outer surface of the side portion and/or the bottom portion of the resin case.

10. The resin case for holding a battery of claim 9, wherein
instead of applying the emetic agent to the outer surface of the side portion and/or the bottom portion of the resin case, the resin case has a rectangular outer shape.
